(19) United States
(12) Patent Application Publication
(10) Pub. No.: US 2019/0380540 A1
(43) Pub. Date: Dec. 19, 2019

(54) COCKTAIL SHAKER WITH TILTABLE SPOUT

(71) Applicant: Scott BODIE, New York, NY (US)

(72) Inventor: Scott BODIE, New York, NY (US)

(73) Assignee: GODINGER SILVER ART LTD.

(21) Appl. No.: 16/008,342

(22) Filed: Jun. 14, 2018

(51) Int. Cl. A47J 43/27

(52) U.S. Cl. CPC A47J 43/27

(57) ABSTRACT

A beverage shaker assembly having a container with a vertical axis (A); a wedge-shaped lid having a bottom edge dimensioned for releasable securement in an open top of the container, and a cap having a bottom surface defining a cavity, the cavity dimensioned for releasable securement to the lid. The lid is rotatable relative to the vertical axis, and the cap is rotatable relative to the lid. The cap has an outer surface defining facial features corresponding to surface features of the container.

### CROSS-REFERENCE TO RELATED APPLICATION

This utility application is a continuation of U.S. Design patent application Ser. No. 29/636,873, filed Feb. 12, 2018, the entire contents of which are incorporated herein by reference.

### BACKGROUND OF THE INVENTION

### Field of the Invention

The present application relates to cocktail shakers, used to mix beverages (usually alcoholic) by shaking.

### Description of the Related Art

A cocktail shaker is a device used to combine, by shaking, a mixture of ingredients to make beverages, which typically contain alcohol. When ice is put in the shaker this allows for a quicker cooling of the mixture before serving. The mixture is typically strained through an attached strainer to only allow the resulting liquid mixture to be poured while maintaining the solid ingredients in the shaker.

U.S. Pat. No. 300,867 to Hauck is generally considered the first 3-piece cocktail shaker with a built-in strainer, just as is used today. This design also included an air-vent to allow for faster pouring of the contents. Other shakers are those disclosed in U.S. Pat. Nos. 2,589,415; 300,867 and 1,969,386. The shakers contain a body in which a beverage or mixture of beverages, with solid ingredients can be mixed, a cover to contain the contents while mixing, and a strainer for straining the contents. The ornamental nature of such shakers, however, is limited. In many situations, bars located in residences serve as focal points for entertaining guests. Thus, bar owners are interested in novelty barware such as is disclosed in U.S. Pat. No. 7,689,501 and U.S. Des. Pat. No. D796,933 in order to enhance the entertainment pleasure of the bar or bar area. With cocktail shakers, however, while the shakers themselves may be configured in various shapes and designs, such items are not poseable in different configurations to enhance their entertainment quality.

There is therefore a need for cocktail shakers capable of being posed in adjustable positions to convey whimsical and entertaining moods.

### SUMMARY OF THE INVENTION

In accordance with a first aspect of the present invention, a beverage shaker assembly includes: a container having a closed bottom wall, an open top, and a side wall extending therebetween for providing a volume in which a beverage can be received, the open top bounded by a rim, the container having an outer surface defining body features having a front, wherein the closed bottom wall is oriented substantially perpendicular with respect to a vertical axis (A); a wedge-shaped lid having a bottom wall bounded by a bottom edge, a top wall, and a side wall extending therebetween, the bottom edge dimensioned for releasable securement in the open top of the container, the top wall of the wedge-shaped lid extending from a narrow front edge of the wedge-shaped lid to a wider back edge of the wedge-shaped lid such that, when the bottom wall of the lid is received in the open top of the container, the top wall of the lid is at an angle with respect to the vertical axis, and a normal axis (B) of the top wall intersects the vertical axis at an angle less than 90 degrees, the top wall of the lid having an opening therein through which the beverage can be poured when the lid is on the container, the lid opening being bounded by a surrounding wall, wherein the lid is positionable in multiple radial orientations about the vertical axis of the container; and a cap having a bottom surface defining a cavity, the cavity dimensioned for releasable securement to the surrounding wall of the lid, the cap having an outer surface defining facial features corresponding to the body surface features, wherein the cap is positionable in multiple radial orientations about the normal axis of the lid.

In another aspect, the opening in the top wall of the lid comprises a plurality of closely separated openings to form a strainer for the beverage.

In another aspect, the bottom of the lid has an outer diameter and a protruding rim with a diameter less than the dimension of the outer diameter, and wherein the diameter of the protruding rim is dimensioned for receipt, in a friction fit engagement, within the open top of the container.

In another aspect, the cap resembles a head of a primate and the container resembles the body of the primate.

In another aspect, the container, lid and rim are formed of metal.

In another aspect, the container, lid and rim are formed by molding.

In another aspect, by positioning the cap at an axial location with respect to the front, a change in an emotional expression of the shaker assembly is conveyed to an observer.

In another aspect, by positioning the lid at an axial location with respect to the front, a change in an emotional expression of the shaker assembly is conveyed to an observer.

In another aspect, by positioning the cap at an axial location with respect to the front, a further change in an emotional expression of the shaker assembly is conveyed to an observer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a front perspective view illustrating the cocktail shaker of the present invention showing the lid and cap in a first position with respect to one another;

FIG. 2 is a front perspective view of the cocktail shaker of the present invention showing the lid and cap a second position with respect to one another;

FIG. 3 is an exploded view of the cocktail shaker of the present invention;

FIG. 4 is another exploded view of the cocktail shaker of the present invention;

FIGS. 5-7 are front views of the cocktail shaker of the present invention with a narrow edge of the lid aligned with a front of the container, and the cap, configured as a head of a primate, in different orientations with respect to the neck and the body;

FIG. 8 is a front view of the cocktail shaker with the lid in a different position than the position of FIGS. 5-7 and with the cap removed; and

FIGS. 9-11 are different views of the cocktail shaker of the present invention with the cap and lid in different positions.

### DETAILED DESCRIPTION OF THE PRESENTLY PREFERRED EMBODIMENTS

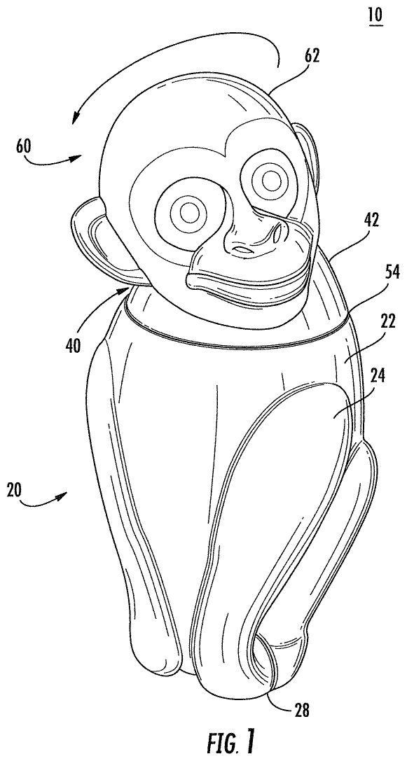

The cocktail shaker assembly 10 in accordance with an embodiment of the present invention will be described making reference to FIGS. 1-9.

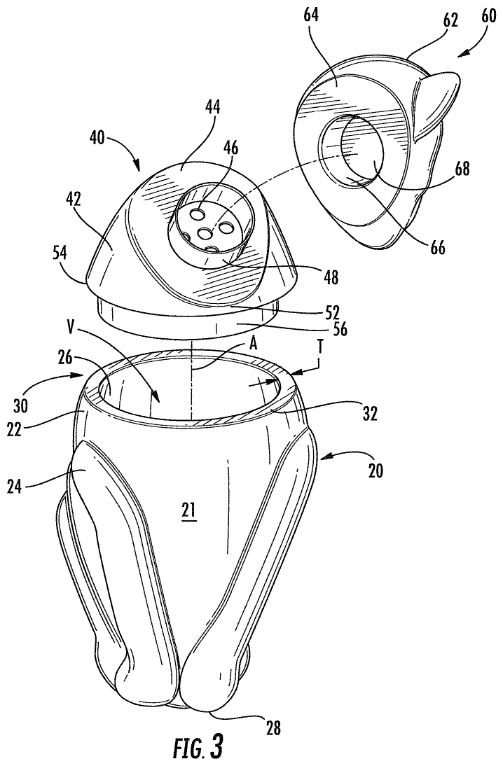

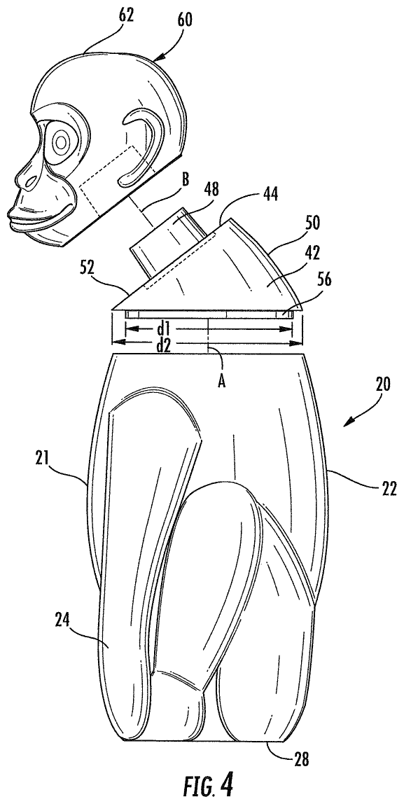

FIG. 1 shows the cocktail shaker assembly 10 in an assembled state. The shaker assembly 10 includes a container 20 for storing a beverage and ingredients, a wedge-shaped lid 40 releasably securable to the container 20, and a cap 60 releasably securable to the wedge-shaped lid 40. In an assembled state, the shaker assembly 10 would not be able to dispense the beverage due to the closing of the top of the container 20 by the combined wedge-shaped lid 40 with the cap 60 secured thereto. The container has a forward facing surface or “front” 21, as is oriented generally along a vertical axis (A) as shown, for example, in FIGS. 3 and 4.

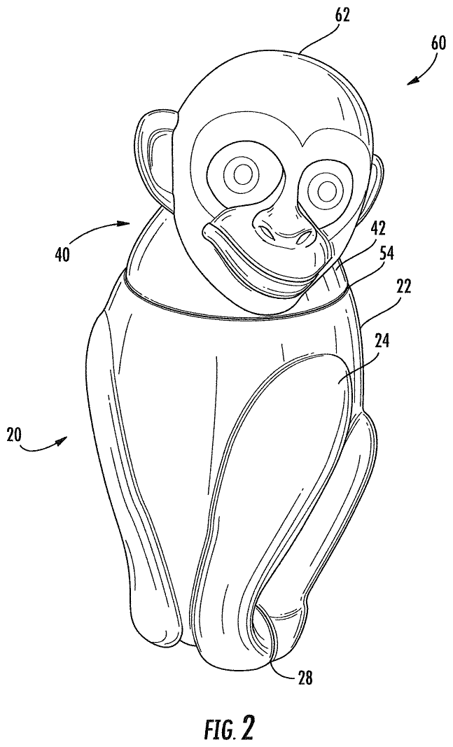

The cap 60 is configured in a manner to be discussed in more detail below to cooperate with and engage the wedge-shaped lid 40 so as to be rotatable, for example in the direction indicated schematically by the arrow shown in FIG. 1, and rotatable in the opposite direction schematically indicated by the arrow. The result of such an opposite rotation is shown in FIG. 2. As will be discussed further below, when the cap is configured as a head, for example of a primate, this tilting of the head can be used to convey a variety of emotional expressions, such as a quizzical expression associated with animal's heads in a tilted orientation.

As can be seen in FIGS. 1 and 2, the container 20 includes an outer surface 22, forming a side wall of the container 20, a closed bottom wall 28, and decorative body features 24 defined by the outer surface 22. As can be seen in the exploded views of FIGS. 3 and 4, the container 20 also has an open top 30 bounded by a rim 32 for providing a volume (V) in which one or more beverages, and solid ingredients, such as mint leaves, citrus peel, ice, etc., can be received. The rim 32 has a thickness (T). The side wall 22 extends between the open top 30 and the closed bottom wall 28.

As can be seen from FIG. 4, the closed bottom wall 28 of the container is oriented substantially perpendicular with respect to the vertical axis (A) of the container 20. Also visible in FIG. 3, the container 20 has an inner surface 26, which surface would be contacting the contents stored in the volume (V).

As shown, for example, in FIGS. 3 and 4, the wedge-shaped lid 40 has a bottom wall bounded by a bottom edge, and a top wall 44 forming an angled surface. The top wall 44 of the lid 40 has at least one lid opening 46 through which the beverage can be poured when the lid 40 is on the container 20. The at least one lid opening 46 comprises a plurality of lid openings 46 in the top wall 44 of the lid 40 to form a strainer for the contents of the container. The plural lid openings 46 are bounded by a surrounding wall 48. As will be discussed further below, the bottom edge of the lid 40 is dimensioned for releasable securement in the open top 30 of the container 20.

The top wall 44 of the wedge-shaped lid 40 extends from a narrow front edge 52 of the wedge-shaped lid to a wider curved back edge wall 50 of the wedge-shaped lid 40. By virtue of this configuration, when the bottom wall of the lid 40 is received in the open top 30 of the container, the top wall 44 of the lid 40 is at an angle with respect to the vertical axis (A), and a normal axis (B) of the top wall 44 intersects the vertical axis at an angle of less than 90 degrees.

The bottom of the lid 40 defines a ledge 54 having a first outer diameter d2 and a protruding rim 56 with a diameter d1 less than the dimension of the outer diameter d2. The diameter of the protruding rim 56 is dimensioned for receipt, in a friction fit or threading engagement, within the open top 30 of the container 20. Preferably, so that the outer interface between the lid 40 and container 20 is smooth, the thickness T of the rim 32 is equal to d2 minus d1.

The cap 60 has an outer surface 62 that defines its overall appearance. In the illustrated embodiment, the outer surface 62 has a shape defining facial features of the head of a primate, in particular a monkey. However, any animal, mythical or actual, may be used. As best seen in FIG. 3, the cap 60 has a bottom mating surface 64 defining a cavity or recess 68 having a recess wall 66.

The cavity 68 is dimensioned for releasable securement, such as, for example, by way of a friction fit, to the surrounding wall 48 of the lid 40. To remove the cap 60, the cap 60 can be twisted and/or lifted away from the lid 40 to overcome a friction fit of the recess wall 66 and the surrounding wall 48 of the lid 40. Conversely, to secure the cap 60, the cap 60 can be pushed toward the lid 40 to provide a secure friction fit. Although a friction fit is preferred, other releasable securing techniques can be used without departing from the scope of the invention, such as with the use of threading.

The adjustable friction fit of the cap 60 also makes the cap 60 positionable in multiple radial orientations about the normal axis B of the lid 40. That is, in addition to securing and detachment, a feature of the present invention allows the tilt of the head of the depicted animal to be set in multiple radial orientations about the normal axis B of the lid 40, in particular, at a radial orientation that may, for example, convey an emotion of the depicted animal.

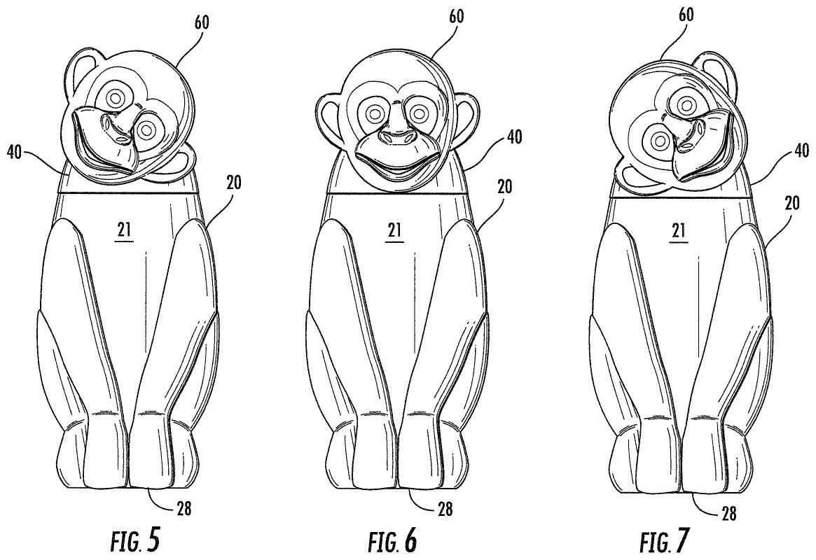

For example, as shown in FIGS. 5-7, the shaker assembly 10 is in its assembled state with the narrow edge 52 of the lid in alignment with the front of the body 21. The cap 60 can be rotated relative to the normal axis B to convey a head tilt toward a right arm of the body as illustrated in FIG. 5, a forward facing orientation as illustrated in FIG. 6, or a head tilt toward a left arm of the body as shown in FIG. 7. Because some animals are known to tilt their head to represent a moment of surprise or inquisitiveness, the radial orientation of the head 60 can convey such emotions.

The outer surface 62 of the cap 60, which defines the facial features, may be representative of the same animal as that of the body surface features 24 of the container 20. In such a case, in the illustrated example, the cap 60 would give the overall impression to the user of the head of a monkey, while the body surface features 24 would, for example, give the overall impression to the user of the legs of a monkey.

Alternatively, to represent certain mythical or fanciful animals, such as, for example, those from ancient Egyptian hieroglyphics, the cap's facial features could give the overall impression of one animal, while the body surface features could give the overall impression of a different animal.

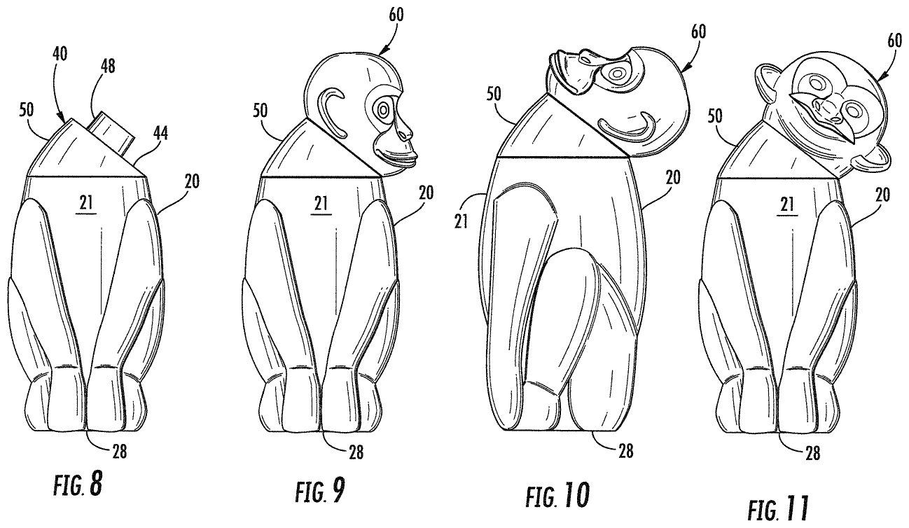

As shown in FIG. 8, the lid can be rotated with respect to vertical axis A such that the narrow edge is not aligned with the front 21 of the body 20. Such positioning allows further configurations of the shaker assembly. For example, by misaligning the lid with respect to the front 21 of the body and then rotating the cap 60, the additional configurations illustrated, by way of example, in FIGS. 9-11 can be realized. Therefore, numerous emotional expressions can be conveyed to an observer, thereby providing an entertainment value to the shaker assembly.

It is preferred that the components of the shaker assembly, namely, the body 20, lid 40 and cap 60, are formed by molding. In one embodiment, these components are formed of stainless steel, but plastic or other known moldable materials may likewise be used. It is preferred that the material be of the type that is suitable for cleaning in a dishwasher.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A beverage shaker assembly, comprising:
a container having a closed bottom wall, an open top, and a side wall extending therebetween for providing a volume in which a beverage can be received, the open top bounded by a rim, the container having an outer surface defining body features resembling body features of an animal, and having a front resembling a front of said animal, wherein the closed bottom wall is oriented substantially perpendicular with respect to a vertical axis (A);
a wedge-shaped lid having a bottom wall bounded by a bottom edge, a top wall, and a side wall extending therebetween, said bottom edge dimensioned for releasable securement in the open top of the container, said top wall of the wedge-shaped lid extending from a narrow front edge of the wedge-shaped lid to a wider back edge of the wedge-shaped lid such that, when the bottom wall of the lid is received in the open top of the container, the top wall of the lid is at an angle with respect to the vertical axis, and a normal axis (B) of the top wall intersects the vertical axis at an angle less than 90 degrees, the top wall of the lid having an opening therein through which the beverage can be poured when the lid is on the container, the lid opening being bounded by a surrounding wall, wherein the lid is positionable in multiple radial orientations about the vertical axis of the container; and
a cap having a bottom surface defining a cavity, the cavity dimensioned for releasable securement to the surrounding wall of the lid, the cap having an outer surface defining facial features corresponding to the body surface features, wherein the cap is positionable in multiple radial orientations about the normal axis of the lid.

2. The beverage shaker assembly of claim 1, wherein the opening in the top wall of the lid comprises a plurality of closely separated openings to form a strainer for the beverage.

3. The beverage shaker assembly of claim 1, wherein the bottom of the lid has an outer diameter and a protruding rim with a diameter less than the dimension of the outer diameter, and wherein the diameter of the protruding rim is dimensioned for receipt, in a friction fit engagement, within the open top of the container.

4. The beverage shaker assembly of claim 1, wherein the cap resembles a head of a primate and the container resembles the body of the primate.

5. The beverage shaker assembly of claim 1, wherein the container, lid and rim are formed of metal.

6. The beverage shaker assembly of claim 1, wherein the container, lid and rim are formed by molding.

7. The beverage shaker assembly of claim 1, wherein the cap has the appearance of an animal head, and the cap is configured to be twistable so as to position the cap at an axial location with respect to the front that provides an appearance of the animal head indicative of a change in an emotional expression of the animal.

8. The beverage shaker assembly of claim 1, wherein the cap has the appearance of an animal head, and the lid is configured to be twistable so as to position the lid at an axial location with respect to the front that provides an appearance of a tilt to the animal head indicative of a change in an emotional expression of the animal.

9. The beverage shaker assembly of claim 8, wherein the cap is configured to be twistable so as to position the cap and lid with respect to one another and at an axial location with respect to the front that provides an appearance of a further tilt to the animal head indicative of a further change in the emotional expression of the animal.

10. The beverage shaker assembly of claim 9, wherein the cap and body correspond to a same animal.

11. The beverage shaker assembly of claim 9, wherein the cap and body do not correspond to a same animal.

12. The beverage shaker assembly of claim 1, wherein the body, lid and cap are comprised of one of steel and plastic.

13. The beverage shaker assembly of claim 1, wherein the body, lid and cap are formed by molding.
